(19) United States
(12) Patent Application Publication
(10) Pub. No.: US 2007/0266840 A1
(43) Pub. Date: Nov. 22, 2007

(54) SAW TOOTH WITH HARD LAYER

(76) Inventors: Adalbert Ottenwaelder, Ofterdingen (DE); Alexander Knebel, Balingen (DE)

Correspondence Address: Striker, Striker & Stenby, 103 East Neck Road, Huntington, NY, 11743, US

(21) Appl. No.: 11/747,964

(22) Filed: May 14, 2007

(30) Foreign Application Priority Data
May 20, 2006 (DE) 20 2006 008 127.5
Jul. 22, 2006 (DE) 10 2006 034 010.8

(51) Int. Cl. B23D 57/00

(52) U.S. Cl. 83/835

(57) ABSTRACT

A saw tooth has a base body comprising a solderable hard metal and a hard layer comprising a material that is harder than the hard metal of the base body; the hard layer is provided on a front face of the base body, and the tooth face has at least one chamfered and/or rounded face portion.

### CROSS-REFERENCE TO A RELATED APPLICATION

The invention described and claimed hereinbelow is also described in German Patent Applications DE 20 2006 008 127.5 filed on May 20, 2006 and DE 10 2006 034 010.8 filed on Jul. 22, 2006. These German Patent Applications, whose subject matter is incorporated here by reference, provide the basis for a claim of priority of invention under 35 U.S.C. 119(a)-(d).

### BACKGROUND OF THE INVENTION

The invention relates to a saw tooth with a surface clad with a hard layer.

Tools, usually machine-driven, used for processing wood, such as saw blades, often have saw teeth of hard metal. The saw teeth essentially determine the cutting properties of the tool. The number, shape and position of the saw teeth define the shape of a cut made with the tool. The material comprising the saw teeth determines the maximum hardness of a material that can be cut with the tool.

From the prior art, such as DE 101 23 752 A1, saw teeth embodied as hollow teeth are known. Because the tooth face is not flat, saw teeth shaped in this way create largely breakage-free cut edges and largely smooth cut faces. By means of one or more cutting edges provided on the tooth face, an acute angle of attack results between the tool and the face that is to be cut, which in turn results in more of a cutting than a shearing cut and causes an elongated, thin chip to be formed. A disadvantage of saw teeth shaped in this way is that the saw teeth, and in particular the tooth flanks that act as the cutting surface and the cutting edges embodied on them must be reground at shorter intervals, which leads to down times of the tool and involves further costs in its operation.

Saw teeth with a flat, diamond-coated tooth face are also known. In such coated saw teeth, a smooth-surfaced layer, as a rule several tenths of a millimeter thick, is applied to the hard metal saw tooth, so that with the diamond-coated saw tooth, very hard materials can be severed. Since diamond as a material comprising the saw tooth coating is a highly wear-resistant cutting material, regrinding of the tooth flanks can be dispensed with. The known diamond-coated saw teeth have a flat tooth face and consequently no cutting surface that is suitable for forming a high-precision cut edge.

### SUMMARY OF THE INVENTION

The object of the invention is to improve both the cutting quality and the service life of a saw tooth.

This object is attained in that a saw tooth has a base body comprising a solderable hard metal and a hard layer comprising a material that is harder than the hard metal of the base body. The hard layer is provided on a front face of the base body, and the tooth face has at least one chamfered and/or rounded face portion.

The tooth face of the saw tooth of the invention is clad with a hard layer, whose material is harder than the hard metal used to produce the base body of the saw tooth. As a result of the chamfered and/or rounded face portion or face portions provided on the tooth face, protrusions and/or edges on the tooth face are created, with the aid of which a material to be cut can be more easily severed. Because of the more-acute angle of entry, a smoother cutting edge that has fewer tears is created. Because of the hard layer, regrinding of the tooth flanks of the saw tooth of the invention can be dispensed with, so that the saw tooth has a long life, and a tool equipped with a saw tooth of the invention has a long service life. The saw tooth of the invention offers both the advantage of high cutting quality and the advantage of a long service life. With the aid of the base body comprising a solderable hard metal, the saw tooth of the invention can be secured to a tool, such as a saw blade, by soldering.

In a preferred embodiment of the saw tooth of the invention, the tooth face is hollow, in particular concave or V-shaped, and preferably has a continuous hard layer.

The advantage of such an embodiment is that two protruding, ideally pointed cutting edges are embodied on the tooth face, which because of the hard layer provided on the tooth face are reinforced and are more wear-resistant. The hard-coated tip or edge assures a durably high-quality cutting performance of the saw tooth of the invention. The surface of the hollow tooth face is for instance part of a cylindrical surface, an oval body surface, an elliptical body surface, or is composed of curved and/or flat face parts. An embodiment of the tooth face of symmetrical and in particular chamfered face portions allows production to be simplified.

In a preferred embodiment of the saw tooth of the invention, the front face of the base body is flat, and the hard layer has difference thicknesses.

In this embodiment, the tooth face is embodied or shaped by the hard layer. The saw tooth of the invention can be produced in such a way that the base body of hard metal is provided with a hard layer either before or after the saw tooth or saw teeth are cut to size. Next, recesses, such as hollow shapes, grooves, and/or flutes are made in the hard layer, and in this the final shape of the tooth face is attained. For this purpose, erosion and in particular spark erosion as well as other physical and/or chemical processes are attractive options. Alternatively, the tooth face may be constructed of individual layers or individual segments of different thicknesses of the hard layer.

In a further preferred embodiment of the saw tooth of the invention, the front face of the base body has the contour of the tooth face with the hard layer.

This embodiment of the invention offers the advantage that for its production, the least possible amount of hard layer material can be used. In the production of such a saw tooth, the shape of the base body is first embodied and then provided with the hard layer. The hard layer is applied to the already-curved tooth face by a suitable process. A saw tooth with a concave tooth face can be produced in such a way that a hard metal provided with a hard layer is cut apart into individual saw teeth. A further option for fabricating a saw tooth of the invention is to use a hard metal which has the thickness of the saw tooth and onto which a hard layer is applied. Next, grooves are made in the hard layer, and the hard metal is cut in strips along the grooves. Cutting through the touching edges of the adjacent grooves creates saw teeth with a hollow tooth face. The fabrication of a larger saw tooth combination is advantageous in terms of easier large-area material machining.

In a further preferred embodiment of the saw tooth of the invention, a chamfer is provided on a tooth spine of the saw tooth and/or on the tooth face.

The material of the hard layer advantageously contains diamond in polycrystalline form. The choice of diamond as an ingredient of the hard layer assures especially high wear resistance of the saw tooth of the invention and creates the capability of severing materials of up to diamond hardness. Alternatively or in addition, the material of the hard layer may contain chromium, titanium, boron, and/or carbon, and as a result great hardness and high wear resistance of the hard layer are attained.

The invention further includes a machine-driven machining tool, in particular a circular saw blade, on which at least one saw tooth of the invention is provided. A machining tool of this kind, such as a bandsaw blade, milling cutter or drill, because of the saw tooth or saw teeth of the invention that are made on it, has a cutting performance with smooth cut faces and long chips and thus assures high cutting quality. A long service life is attained because regular regrinding is dispensed with. Moreover, in an embodiment of the hard layer of diamond, materials that are especially hard can be severed with the aid of the machining tool of the invention, and with the tool of the invention, long machining times with cutting quality that remains constant throughout are possible.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIGS. 1 and 2 each show a section through a saw tooth according to the invention; and

FIG. 3 is a detail of a machining tool of the invention.

### DESCRIPTION OF THE PREFERRED EMBODIMENTS

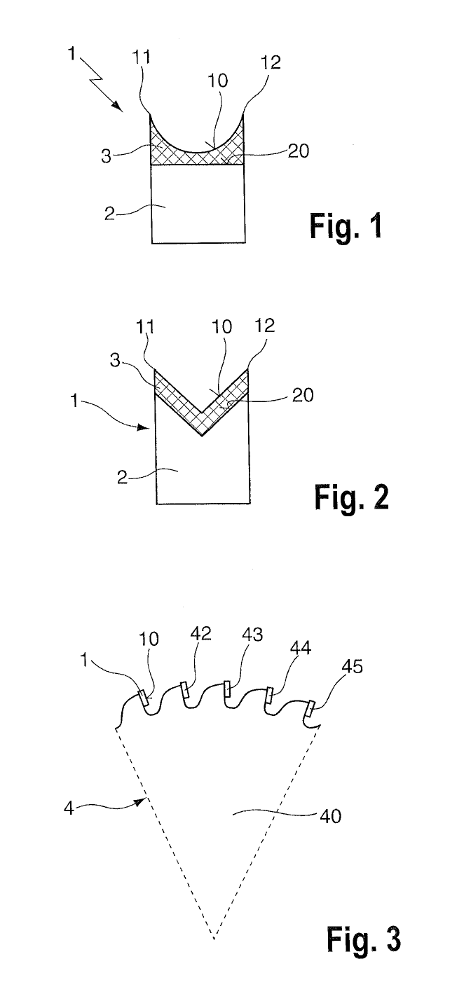

FIG. 1 shows a saw tooth 1 of the invention in a horizontal section. A base body 2 of the saw tooth 1 has a square cross section. A hard layer 3 is applied to a front face 20 of the base body 2, over the full surface. An outer surface, facing away from the base body 2, of the hard layer 3 is a completely rounded face portion, which forms a tooth face 10 of the saw tooth 1. The tooth height, that is, the length measured at the tooth face 10, is as a rule from 1 to 10 mm. Because of the concave, hollow embodiment of the tooth face 10 as shown, at the two edges of the tooth face 10 a cutting edge 11, shown in section as a pointed tip, and a further cutting edge 12, also shown as a pointed tip, are embodied.

The cutting edges 11, 12 formed of the material of the hard layer 3, on entering into a material that is to be cut, lead to a precise cut. An embodiment of two cutting edges 11, 12, by means of a uniform contact, which in particular distributes forces equally, of the cutting edges 11, 12 on the face to be cut of a material such as wood that is to be cut and thus additionally improves the cutting quality of the saw tooth 1 of the invention. With the aid of the cutting edges 11, 12, the saw tooth 1 of the invention can sever a material which at maximum has the hardness of the material of the hard layer, advantageously diamond. The shape of the tooth face 10 is embodied entirely by the hard layer 3, which rests on the flat front face 20 of the base body 2. The tooth face 10 is shaped for instance in an erosion production process from the hard layer 3, which in the prefabricated state may have a thickness which is greater than or equal to the height shown here of the cutting edges 11, 12.

In FIG. 2, a further embodiment of the saw tooth 1 of the invention is shown. The front face 20 of the base body 2 is uneven and is put together from two symmetrically located chamfered face portions. The contour of the front face 20 is V-shaped, embodied mirror-symmetrically to the middle. In the embodiment shown, the hard layer 3 provided on the front face 20 of the base body 2 has a uniform thickness. The contour of the tooth face 10 follows the contour of the front face 20, so that the tooth face 10 likewise has two chamfered face portions located symmetrically in the shape of a V and consequently has two peripheral cutting edges 11, 12.

The advantage of this kind of embodiment is that to produce the saw tooth 1 of the invention, and in particular to attach or apply the hard layer 3, a smaller quantity of hard layer material can be used. It is furthermore conceivable in this embodiment for the hard layer 3 to have different thicknesses, specifically in such a way that in the region of the cutting edges 11, 12, the hard layer 3 has a greater thickness than in the middle region of the tooth face, which contributes little to the cutting performance of the saw tooth 1.

In FIG. 3, an attachment of the saw tooth 1 to a machining tool 4 is shown. This figure shows a sector of the wood machining tool 4 embodied as a circular saw blade. A saw blade blank 40 has a comb like row of teeth on its peripheral surface, and a second saw tooth 42, a third saw tooth 43, a fourth saw tooth 44, and a fifth saw tooth 45 are correspondingly mounted on the successively located combs of the saw tooth 1. The saw teeth 1, 2, 43, 44 and 45 of the invention are fastened by their respective base bodies of solderable hard metal to the saw blade blank 40.

The base bodies of the saw teeth 1, 2, 43, 44 and 45 have corresponding attachment means for making a form lock with the saw blade blank 40. The tooth faces of the saw teeth 1, 2, 43, 44 and 45 of the invention, like the tooth face 10 of the saw tooth 1, are oriented in the tangential direction. The cutting edges embodied in pointed form according to the invention on the saw teeth 1, 2, 43, 44 and 45 assure high dimensional accuracy and rectilinearity of a cut made with the machining tool 4. Additional sharpening and/or grinding of the saw teeth 1, 2, 43, 44 and 45, in the embodiment of the machining tool of the invention, is unnecessary, or is needed only at very long time intervals, which increases the service life of the machining tool 4.

Further embodiments of the saw tooth 1 of the invention with one or more, preferably parallel cutting edges and with one or more chamfers provided on the tooth face 10 and/or on a tooth spine of the saw tooth 1, are conceivable. It is furthermore conceivable for only individual portions of the front face 20 to be covered with the hard layer 3. Those portions may be limited to the regions of the cutting edges where the material of the hard layer 3 has the function of a highly wear-resistant cutting material.

To improve the cutting quality and the service life, a saw tooth 1 of the invention has a base body 2 of a solderable hard metal and a hard layer 3 of a material which is harder than the hard metal of the base body 2. Chamfered and/or rounded face portions provided on the tooth face 10 create cutting edges 11 and 12, which because of the hard layer 3 provided on the tooth face 10 are reinforced and more wear-resistant and which assure a durably high-quality cutting performance of the saw tooth 1 of the invention. A cutting performance that has smooth cut faces is imparted to a machining tool 4 by a saw tooth or saw teeth 1, 2, 43, 44 and 45 according to the invention made on it and thus this machining tool assures a high cutting quality.

It will be understood that each of the elements described above, or two or more together, may also find a useful application in other types of constructions differing from the type described above.

While the invention has been illustrated and described as embodied in a saw tooth with hard layer, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A saw tooth, comprising a base body having a front face and a solderable hard metal; and a hard layer comprising a material that is harder than the hard metal of said base body, said hard layer being provided on said front face of said base body and having a tooth face with at least one portion selected from the group consisting of a chamfered face portion, a rounded face portion, and both.

2. A saw tooth as defined in claim 1, wherein said tooth face of said hard layer is hollow.

3. A saw tooth as defined in claim 2, wherein said tooth face has a shape selected from the group consisting of a concave shape and a V shape.

4. A saw tooth as defined in claim 1, wherein said front face of said base body is flat, and said hard layer has different thicknesses.

5. A saw tooth as defined in claim 1, wherein said front face of said base body has a contour of said tooth face with said hard layer.

6. A saw tooth as defined in claim 1, wherein a chamfer is provided on an element selected from the group consisting of a tooth spine of the saw tooth, the tooth face, and both.

7. A saw tooth as defined in claim 1, wherein the material of said hard layer contains diamond.

8. A saw tooth as defined in claim 7, wherein the material of said hard layer contains the diamond in polycrystalline form.

9. A machine-driven machining tool, comprising a machining tool selected from the group consisting of a band saw blade, a milling cutter, and a drill having at least one saw tooth, said saw tooth having a base body having a front face and a solderable hard metal, and a hard layer comprising a material that is harder than the hard metal of said base body, said hard layer being provided on said front face of said base body and having a tooth face with at least one portion selected from the group consisting of a chamfered face portion, a rounded face portion, and both.

10. A machine-driven machining tool as defined in claim 9, wherein the machine-driven machining tool is configured as a circular saw blade.
